(19) United States
(12) Patent Application Publication
(10) Pub. No.: US 2026/0260832 A1
(43) Pub. Date: Sep. 3, 2026

(54) ELECTROMAGNETIC RELAY

(71) Applicant: OMRON Corporation, Kyoto-shi, Kyoto (JP)

(72) Inventors: Ayata HORIE, Kyoto-shi, Kyoto (JP); Shinichi OGAWA, Kyoto-shi, Kyoto (JP); Naoki KAWAGUCHI, Kyoto-shi, Kyoto (JP)

(21) Appl. No.: 19/159,612

(22) PCT Filed: Feb. 20, 2024
(86) PCT No.: PCT/JP2024/006051

§ 371 Date: Aug. 26, 2025

(30) Foreign Application Priority Data
Mar. 14, 2023 (JP) 2023-039488

(51) Int. Cl. H01H 50/12; H01H 50/14; H01H 50/54

(52) U.S. Cl. CPC H01H 50/12; H01H 50/14; H01H 50/546

(57) ABSTRACT

The electromagnetic relay includes a housing, a contact case, a first fixed terminal, a movable contact piece, and a first conductive member. The contact case is disposed inside the housing. The first fixed terminal is disposed inside the housing and includes a first fixed contact disposed inside the contact case. The movable contact piece is disposed inside the contact case and includes a first movable contact facing the first fixed contact. The first conductive member is fixed to the first fixed terminal. The first conductive member includes a first inner portion disposed inside the housing and a first outer portion disposed outside the housing. The housing includes a first heat-dissipating portion configured to dissipate heat generated at the first inner portion of the first conductive member. The first heat-dissipating portion is arranged adjacent to at least part of the first inner portion of the first conductive member.

### CROSS-REFERENCE TO RELATED APPLICATIONS

This application is the U.S. National Phase of International Application No. PCT/JP2024/006051, filed on Feb. 20, 2024. That application claims priority to Japanese Patent Application No. 2023-039488, filed Mar. 14, 2023. The contents of those two applications are incorporated by reference herein in their entireties.

### FIELD

The present invention relates to an electromagnetic relay.

### BACKGROUND

In some electromagnetic relays, a conductive member is connected to a fixed terminal and is used as a conduction path from the fixed terminal to an external device (see Japanese Patent No. 7,117,567).

In conventional electromagnetic relays, the conductive member is covered by the housing except for the end portion connected to the external device. Thus, the heat generated at the conductive member during conduction cannot be dissipated efficiently to the outside of the housing.

An object of the claimed invention is to provide an electromagnetic relay that can efficiently dissipate heat generated at the conductive member fixed to the fixed terminal.

### SUMMARY

An electromagnetic relay according to a first aspect of the claimed invention includes a housing, a contact case, a first fixed terminal, a movable contact piece, and a first conductive member. The contact case is disposed inside the housing. The first fixed terminal is disposed inside the housing and includes a first fixed contact disposed inside the contact case. The movable contact piece is disposed inside the contact case and includes a first movable contact facing the first fixed contact. The first conductive member is fixed to the first fixed terminal and includes a first inner portion disposed inside the housing and a first outer portion disposed outside the housing. The housing includes a first heat-dissipating portion configured to dissipate heat generated at the first inner portion of the first conductive member. The first heat-dissipating portion is disposed adjacent to at least part of the first inner portion of the first conductive member.

In this electromagnetic relay, the first heat-dissipating portion of the housing configured to dissipate the heat that is generated at the first inner portion of the first conductive member is disposed adjacent to at least part of the first inner portion of the first conductive member. Thus, the heat generated at the first conductive member can be efficiently dissipated by the first heat-dissipating portion of the housing.

The first heat-dissipating portion may include an opening that exposes at least part of the first inner portion of the first conductive member. In this case, the heat generated at the first conductive member can be efficiently dissipated with a simple structure.

The first inner portion may include a fixing portion that is fixed to the first fixed terminal. The first heat-dissipating portion may be disposed adjacent to the fixing portion. In this case, the first heat-dissipating portion is arranged close to the first fixed terminal, which is the heat source. Thus, the heat generated at the first conductive member can be efficiently dissipated.

The first heat-dissipating portion may be made of metal and may be exposed outside the housing. In this case, the heat generated at the first conductive member can be efficiently dissipated by the first heat-dissipating portion.

The electromagnetic relay may further include a second fixed terminal disposed inside the housing and a second conductive member fixed to the second fixed terminal. The second fixed terminal may include a second fixed contact disposed inside the contact case. The second conductive member may include a second inner portion disposed inside the housing and a second outer portion disposed outside the housing. The movable contact piece may further include a second movable contact facing the second fixed contact. The housing may further include a second heat-dissipating portion configured to dissipate heat generated at the second inner portion of the second conductive member. The second heat-dissipating portion may be disposed adjacent to at least part of the second inner portion of the second conductive member. In this case, the heat generated at the second conductive member can be efficiently dissipated by the second heat-dissipating portion of the housing.

### BRIEF DESCRIPTION OF THE DRAWINGS

FIG. 1 is a top view of an electromagnetic relay.

FIG. 2 is a front view of the electromagnetic relay.

FIG. 3 is a cross-sectional view of the electromagnetic relay taken along line III-III.

FIG. 4 is a perspective view of a first conductive member and a second conductive member.

FIG. 5 is a diagram illustrating a modification of a first heat-dissipating portion.

FIG. 6 is a diagram illustrating a modification of the first heat-dissipating portion.

### DETAILED DESCRIPTION

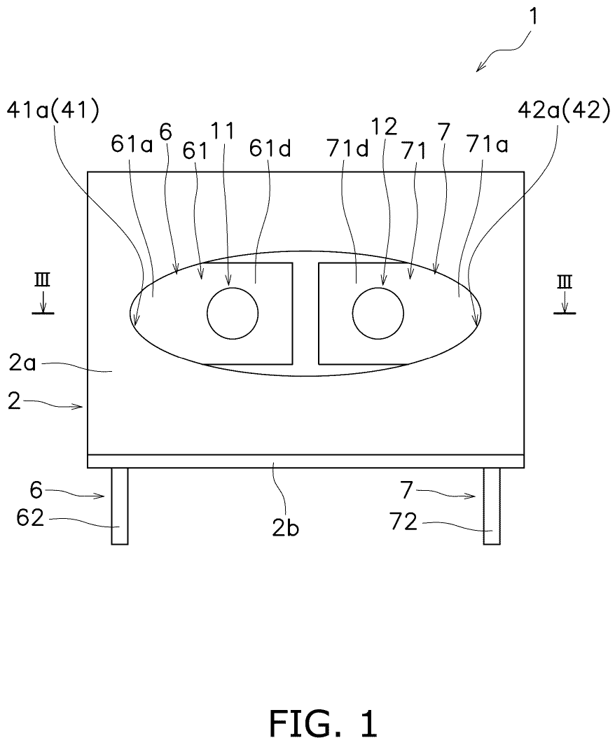

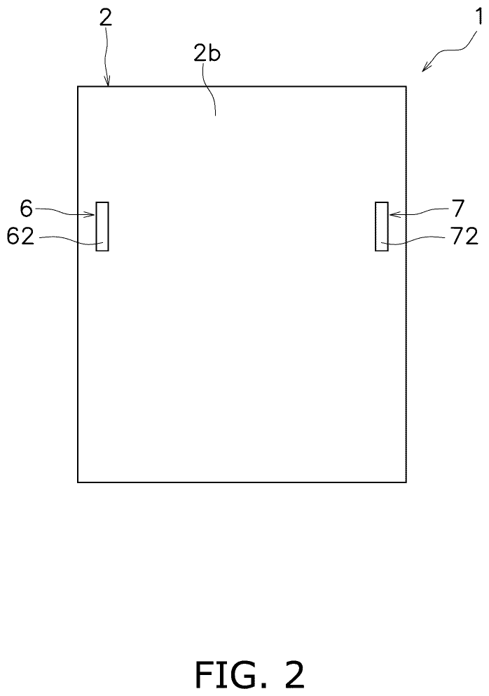

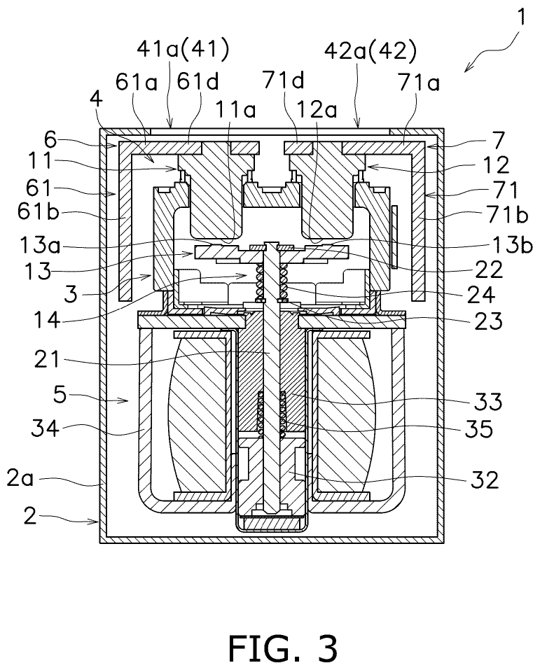

Hereinafter, an electromagnetic relay 1 according to one embodiment will be described with reference to the drawings. FIG. 1 is a top view of the electromagnetic relay 1. FIG. 2 is a front view of the electromagnetic relay 1. FIG. 3 is a cross-sectional view of the electromagnetic relay 1. In referencing the drawings, the following orientations are used: in FIG. 3, the upper side is referred to as “top,” the lower side as “bottom,” the left side as “left,” and the right side as “right.” The front side of the page in FIG. 3 is referred to as “front,” and the back side as “rear.” These directions are defined for convenience of description, and do not limit the arrangement directions of the electromagnetic relay 1.

As shown in FIG. 1, the electromagnetic relay 1 includes a housing 2, a contact case 3, a contact device 4, a drive device 5, a first conductive member 6, and a second conductive member 7.

The housing 2 is made of insulating material such as resin. The housing 2 includes a case 2a and a cover 2b. The case 2a is a substantially rectangular box with its front side open. The cover 2b covers the front of the case 2a. The housing 2 forms an internal space with the case 2a and the cover 2b.

The contact case 3 is disposed inside the housing 2 and is accommodated there. The contact case 3 is made of insulating material such as resin.

The contact device 4 includes a first fixed terminal 11, a second fixed terminal 12, a movable contact piece 13, and a movable mechanism 14. The first fixed terminal 11, the second fixed terminal 12, and the movable contact piece 13 are formed from conductive material.

The first fixed terminal 11 is a columnar terminal. In the present embodiment, the first fixed terminal 11 has a cylindrical shape. The first fixed terminal 11 is disposed inside the housing 2. The first fixed terminal 11 extends across both the interior and exterior of the contact case 3. The first fixed terminal 11 is supported by the contact case 3.

The first fixed terminal 11 includes a first fixed contact 11a. The first fixed contact 11a is disposed inside the contact case 3.

The second fixed terminal 12 is a cylindrical terminal. The second fixed terminal 12 is spaced apart from the first fixed terminal 11 in the left-right direction. The second fixed terminal 12 is disposed inside the housing 2. The second fixed terminal 12 extends across both the interior and exterior of the contact case 3. The second fixed terminal 12 is supported by the contact case 3.

The second fixed terminal 12 includes a second fixed contact 12a. The second fixed contact 12a is disposed inside the contact case 3.

The movable contact piece 13 is disposed inside the contact case 3. The movable contact piece 13 extends in the left-right direction. The movable contact piece 13 is configured to be movable in the up-down direction. The movable contact piece 13 is movable between a closed position, in which it contacts the first fixed contact 11a and the second fixed contact 12a, and an open position, in which it is separated from the first fixed contact 11a and the second fixed contact 12a.

The movable contact piece 13 includes a first movable contact 13a and a second movable contact 13b. The first movable contact 13a is disposed below the first fixed contact Ila. The first movable contact 13a faces the first fixed contact 11a in the up-down direction and is configured to contact the first fixed contact 11a. The second movable contact 13b is disposed below the second fixed contact 12a. The second movable contact 13b is facing the second fixed contact 12a in the up-down direction and is configured to contact the second fixed contact 12a.

The movable mechanism 14 supports the movable contact piece 13. The movable mechanism 14 includes a drive shaft 21, a first retaining member 22, a second retaining member 23, and a contact spring 24. The drive shaft 21 is connected to the movable contact piece 13. The drive shaft 21 extends and passes through the movable contact piece 13 in the up-down direction. The drive shaft 21 is movable in the up-down direction.

The first retaining member 22 is fixed to the drive shaft 21 above the movable contact piece 13. The second retaining member 23 is fixed to the drive shaft 21 below the movable contact piece 13. The contact spring 24 is disposed between the movable contact piece 13 and the second retaining member 23. The contact spring 24 biases the movable contact piece 13 in the contact direction via the second retaining member 23.

The drive device 5 moves the movable mechanism 14 between a closed position and an open position by electromagnetic force. The drive device 5 moves the movable contact piece 13 in the up-down direction via the drive shaft 21. The drive device 5 includes a coil 31, a movable iron core 32, a fixed iron core 33, a yoke 34, and a return spring 35.

The coil 31 generates a magnetic force that moves the movable iron core 32 upward. The movable iron core 32 is connected to the drive shaft 21 so as to be movable integrally therewith. The fixed iron core 33 is disposed at a position facing the movable iron core 32. The yoke 34 is arranged so as to surround the coil 31. The return spring 35 is disposed between the movable iron core 32 and the fixed iron core 33. The return spring 35 biases the movable iron core 32 downward.

The operation of the electromagnetic relay 1 when a voltage is applied to the coil 31 is the same as in conventional relays and thus will not be described. It should be noted that FIG. 3 illustrates a state in which no voltage is applied to the coil 31.

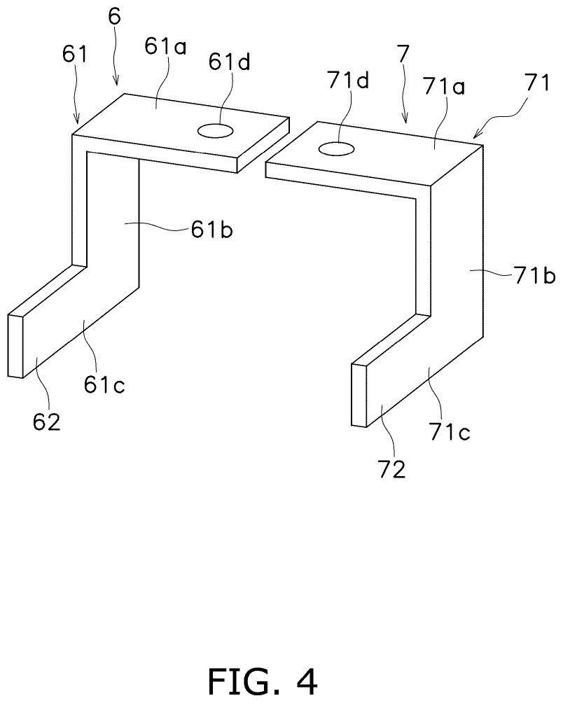

The first conductive member 6 and the second conductive member 7 are made of conductive material. As illustrated in FIG. 4, the first conductive member 6 and the second conductive member 7 are formed by bending metal plates. The first conductive member 6 and the second conductive member 7 are electrically connected to the contact device 4 and form a current path.

The first conductive member 6 is connected to the first fixed terminal 11. The first conductive member 6 includes a first inner portion 61 and a first outer portion 62.

The first inner portion 61 is disposed inside the housing 2 and outside the contact case 3. The first inner portion 61 includes a first conductive portion 61a, a second conductive portion 61b, a third conductive portion 61c, and a fixing portion 61d.

The first conductive portion 61a is disposed above the first fixed terminal 11 and is connected to the first fixed terminal 11. The first conductive portion 61a extends in the left-right direction.

The second conductive portion 61b extends in the up-down direction. The second conductive portion 61b is disposed to the left side of the contact case 3. The second conductive portion 61b is connected to the first conductive portion 61a and extends downward from the left end of the first conductive portion 61a. When viewed from the left-right direction, the second conductive portion 61b overlaps with the first fixed contact 11a and the first movable contact 13a. During conduction, the direction of current flowing through the second conductive portion 61b is opposite to the direction of current flowing through the first fixed terminal 11.

The third conductive portion 61c is connected to the second conductive portion 61b. The third conductive portion 61c extends in the front-rear direction and extends forward from the lower end of the second conductive portion 61b.

The fixing portion 61d is disposed at the right end of the first conductive portion 61a. The fixing portion 61d is arranged above the first fixed terminal 11 and is fixed to the first fixed terminal 11.

The first outer portion 62 is disposed outside the housing 2. The first outer portion 62 extends forward from the front end of the third conductive portion 61c. The first outer portion 62 protrudes forward from the front surface (cover 2b) of the housing 2 and is exposed outside the housing 2. The first outer portion 62 is to be electrically connected to an external device (not shown).

The second conductive member 7 is connected to the second fixed terminal 12. The second conductive member 7 has a shape symmetrical to the first conductive member 6 in the left-right direction. The second conductive member 7 includes a second inner portion 71 arranged inside the housing 2 and a second outer portion 72 arranged outside the housing 2. The second inner portion 71 is disposed inside the housing 2 and outside the contact case 3. The second inner portion 71 includes a first conductive portion 71a, a second conductive portion 71b, a third conductive portion 71c, and a fixing portion 71d. Since the shapes of the respective portions of the second conductive member 7 are the same as those of the first conductive member 6, detailed explanation is omitted.

The housing 2 includes a first heat-dissipating portion 41 and a second heat-dissipating portion 42. The first heat-dissipating portion 41 dissipates heat generated at the first inner portion 61 of the first conductive member 6. The first heat-dissipating portion 41 includes an opening 41a configured to expose at least part of the first inner portion 61 of the first conductive member 6. The opening 41a is located in the top surface of the housing 2. The opening 41a is a hole penetrating the top surface of the housing 2 in the up-down direction. The opening 41a is arranged adjacent to the first conductive portion 61a and the fixing portion 61d. The first conductive portion 61 a and the fixing portion 61d are exposed through the opening 41a and are visible through the opening 41a. The opening 41a may be formed in a mesh or lattice pattern. If formed in a mesh or lattice pattern, the opening 41a may be made of metallic material.

The second heat-dissipating portion 42 is configured to dissipate heat generated at the second inner portion 71 of the second conductive member 7. The second heat-dissipating portion 42 includes an opening 42a configured to expose at least part of the second inner portion 71 of the second conductive member 7. The opening 42a is located in the top surface of the housing 2. The opening 42a is disposed adjacent to the first conductive portion 71a and the fixing portion 71d. In this embodiment, the opening 42a is in communication with the opening 41a.

In this electromagnetic relay 1, since the first heat-dissipating portion 41 of the housing 2 is arranged adjacent to the fixing portion 61d of the first inner portion 61 of the first conductive member 6, the heat generated at the first conductive member 6 can be efficiently dissipated through the first heat-dissipating portion 41 of the housing 2. Moreover, since the first heat-dissipating portion 41 includes the opening 41a, heat generated at the first conductive member 6 can be efficiently dissipated with a simple structure. The heat generated at the second conductive member 7 can be efficiently dissipated through the opening 42a of the second heat-dissipating portion 42.

An embodiment of the electromagnetic relay according to one aspect of the claimed invention has been described. However, the claimed invention is not limited to the above embodiment and may be subject to various modifications without departing from the spirit and scope of the invention.

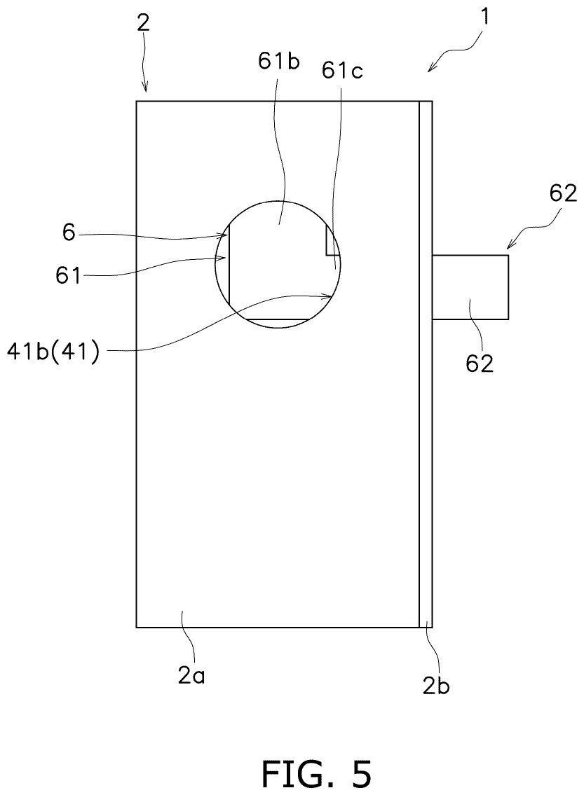

The configuration of the first heat-dissipating portion 41 and the second heat-dissipating portion 42 may be modified. The location or shape of the openings 41a and 42a may also be changed. For example, as illustrated in FIG. 5, the first heat-dissipating portion 41 may include an opening 41b located adjacent to at least one of the second conductive portion 61b and the third conductive portion 61c. In the embodiment in FIG. 5, the opening 41b is located in the left-side surface of the housing 2. At least one of the second conductive portion 61b and the third conductive portion 61c may be exposed through the opening 41b.

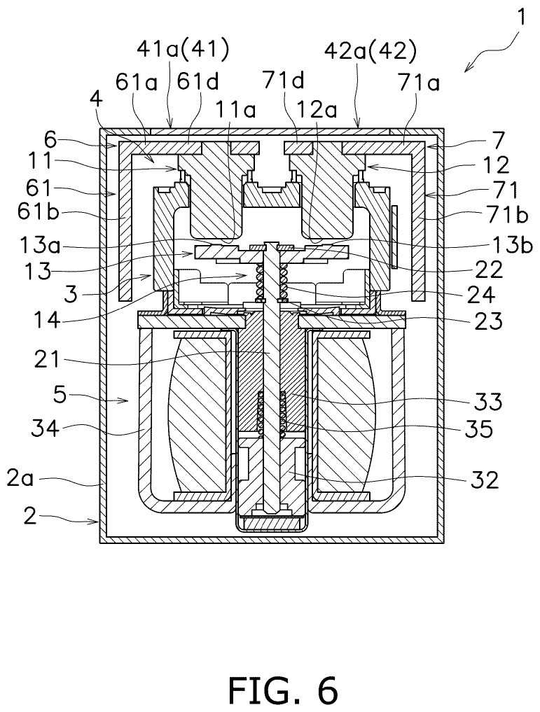

As illustrated in FIG. 6, the first heat-dissipating portion 41 and the second heat-dissipating portion 42 may be made of metal. In this case, the first heat-dissipating portion 41 may be configured to cover at least part of the first inner portion 61 and be exposed outside from the housing 2. If the opening 41a is formed in a mesh or lattice pattern, the opening 41a may be made of metal material.

A cooling member may be positioned in the opening 41a. In such a case, the heat generated at the first conductive member 6 can be dissipated more efficiently.

### REFERENCE NUMERALS

1: Electromagnetic relay, 2: Housing, 3: Contact case, 6: first conductive member, 11: First fixed terminal, 11a: First fixed contact, 13: Movable contact piece, 41: First heat-dissipating portion, 41a: Opening, 61: First inner portion, 62: First outer portion, 61d: Fixing portion

What is claimed is:

1. An electromagnetic relay, comprising:
a housing;
a contact case disposed inside the housing;
a first fixed terminal disposed inside the housing, the first fixed terminal including a first fixed contact disposed inside the contact case;
a movable contact piece disposed inside the contact case, the movable contact piece including a first movable contact facing the first fixed contact; and
a first conductive member fixed to the first fixed terminal, the first conductive member including a first inner portion disposed inside the housing and a first outer portion disposed outside the housing,
the housing including a first heat-dissipating portion configured to dissipate heat generated at the first inner portion of the first conductive member,
the first heat-dissipating portion being disposed adjacent to at least part of the first inner portion of the first conductive member.

2. The electromagnetic relay according to claim 1, wherein
the first heat-dissipating portion includes an opening that exposes at least part of the first inner portion of the first conductive member.

3. The electromagnetic relay according to claim 1, wherein
the first inner portion includes a fixing portion fixed to the first fixed terminal, and
the first heat-dissipating portion is disposed adjacent to the fixing portion.

4. The electromagnetic relay according to claim 1, wherein
the first heat-dissipating portion is made of metal and is exposed outside the housing.

5. The electromagnetic relay according to claim 1, further comprising:
a second fixed terminal disposed inside the housing, the second fixed terminal including a second fixed contact disposed inside the contact case; and
a second conductive member fixed to the second fixed terminal, the second conductive member including a second inner portion disposed inside the housing and a second outer portion disposed outside the housing, wherein
the movable contact piece further includes a second movable contact facing the second fixed contact,
the housing further includes a second heat-dissipating portion configured to dissipate heat generated at the second inner portion of the second conductive member, and
the second heat-dissipating portion is disposed adjacent to at least part of the second inner portion of the second conductive member.

6. The electromagnetic relay according to claim 2, wherein
the first inner portion includes a fixing portion fixed to the first fixed terminal, and
the first heat-dissipating portion is disposed adjacent to the fixing portion.

7. The electromagnetic relay according to claim 2, wherein
the first heat-dissipating portion is made of metal and is exposed outside the housing.

8. The electromagnetic relay according to claim 2, further comprising:
a second fixed terminal disposed inside the housing, the second fixed terminal including a second fixed contact disposed inside the contact case; and
a second conductive member fixed to the second fixed terminal, the second conductive member including a second inner portion disposed inside the housing and a second outer portion disposed outside the housing, wherein
the movable contact piece further includes a second movable contact facing the second fixed contact,
the housing further includes a second heat-dissipating portion configured to dissipate heat generated at the second inner portion of the second conductive member, and
the second heat-dissipating portion is disposed adjacent to at least part of the second inner portion of the second conductive member.
